(19) United States
(12) Patent Application Publication
(10) Pub. No.: US 2025/0132638 A1
(43) Pub. Date: Apr. 24, 2025

(54) MULTI-MOTOR ELECTRIC-VEHICLE DRIVE UNITS

(71) Applicant: Atieva, Inc., Newark, CA (US)

(72) Inventor: Dimitri Bassis, Union City, CA (US)

(21) Appl. No.: 18/689,308

(22) PCT Filed: Aug. 16, 2022
(86) PCT No.: PCT/US2022/074997

§ 371 Date: Mar. 5, 2024

Related U.S. Application Data
(60) Provisional application No. 63/260,948, filed on Sep. 7, 2021.

(51) Int. Cl. H02K 9/193; B60K 1/02; B60L 15/00; H02K 5/20; H02K 11/33

(52) U.S. Cl. CPC H02K 9/193; B60K 1/02; B60L 15/007; H02K 5/203; H02K 11/33; H02K 2205/09

(57) ABSTRACT

A multi-motor electric-vehicle drive unit system comprises: a first drive unit comprising: a first motor casing; a first oil reservoir mounted to a bottom of the first motor casing; and a first inverter mounted to the first motor casing, wherein the first drive unit is installed so that the first inverter has a first orientation; and a second drive unit comprising: a second motor casing, wherein the second motor casing is identical to the first motor casing; a second oil reservoir mounted to a bottom of the second motor casing, wherein the second oil reservoir has a different shape than the first oil reservoir; and a second inverter mounted to the second motor casing, wherein the second drive unit is installed so that the second inverter has a second orientation, the second orientation different from the first orientation.

### CROSS-REFERENCE TO RELATED APPLICATION

This application claims priority to U.S. Patent Application No. 63/260,948, filed on Sep. 7, 2021, and entitled “MULTI-MOTOR ELECTRIC-VEHICLE DRIVE UNITS,” the disclosure of which is incorporated by reference herein in its entirety.

### TECHNICAL FIELD

This document relates to multi-motor electric-vehicle drive units.

### BACKGROUND

High-performance electric vehicles can use a front drive unit and a rear drive unit to provide all-wheel drive. These motors may be produced in high volume and typically require high pressure die-cast aluminum exterior case parts. Moreover, the front and rear drive units may be very different from each other. The manufacturing may use a dedicated factory assembly line for the front drive unit and an entirely separate dedicated factory assembly line for the rear drive unit. A design with significantly different front and rear drive units will require multiple high pressure die cast tooling and dedicated machining, which increases cost and the space requirements for manufacturing and assembly.

### SUMMARY

In an aspect, a multi-motor electric-vehicle drive unit system comprises: a first drive unit comprising: a first motor casing; a first oil reservoir mounted to a bottom of the first motor casing; and a first inverter mounted to the first motor casing, wherein the first drive unit is installed so that the first inverter has a first orientation; and a second drive unit comprising: a second motor casing, wherein the second motor casing is identical to the first motor casing; a second oil reservoir mounted to a bottom of the second motor casing, wherein the second oil reservoir has a different shape than the first oil reservoir; and a second inverter mounted to the second motor casing, wherein the second drive unit is installed so that the second inverter has a second orientation, the second orientation different from the first orientation.

Implementations can include any or all of the following features. Each of the first and second motor casings has a cylindrical shape. The second motor casing is identical to the first motor casing due to the first and second motor casings being die cast. The first inverter has an identical mechanical structure to the second inverter. The multi-motor electric-vehicle drive unit system further comprises: first software in the first inverter, the first software configured for controlling operation of the first drive unit with the first inverter in the first orientation; and second software in the second inverter, the second software different from the first software, the second software configured for controlling operation of the second drive unit with the second inverter in the second orientation. The first drive unit further comprises a first mount at the first motor casing, the first mount configured for installing the first drive unit so that the first inverter has the first orientation; and the second drive unit further comprises a second mount at the second motor casing, the second mount different from the first mount, the second mount configured for installing the second drive unit so that the second inverter has the second orientation. The first drive unit further comprises a brace, wherein a first end of the first mount connects to the first motor casing, and wherein the brace connects a second end of the brace to the first motor casing, the second end being opposite to the first end. The brace and the first mount enclose a heat exchanger for the first drive unit. Each of the first and second motor casings initially includes a first drain port structure and a second drain port structure, wherein the first drain port structure of the first motor casing is machined into a first drain port and wherein the second drain port structure of the first motor casing is not functional, and wherein the first drain port structure of the second motor casing is not functional and wherein the second drain port structure of the second motor casing is machined into a second drain port. Each of the first and second motor casings initially includes a first oil inlet structure and a second oil inlet structure, wherein the first oil inlet structure of the first motor casing is machined into a first oil inlet and wherein the second oil inlet structure of the first motor casing is not functional, and wherein the first oil inlet structure of the second motor casing is not functional and wherein the second oil inlet structure of the second motor casing is machined into a second oil inlet. Each of the first and second motor casings further includes a common oil inlet channel extending axially, and wherein the first and second oil inlet structures extend circumferentially in opposite directions from the common oil inlet channel. Each of the first and second oil inlet structures extends circumferentially about 45 degrees about a rotor rotation axis from the common oil inlet channel. The first and second drive units are installed so that the first and second orientations comprise a rotation of the second drive unit, relative to the first drive unit, about a rotor rotation axis. The rotation is about 90 degrees. The first motor casing includes a first inverter mount, wherein the first inverter is mounted to the first motor casing using the first inverter mount; and the second motor casing includes a second inverter mount, the second inverter mount identical to the first inverter mount, wherein the second inverter is mounted to the second motor casing using the second inverter mount. The first drive unit further comprises a first oil system that includes the first oil reservoir; and the second drive unit further comprises a second oil system that includes the second oil reservoir. The first oil system further comprises a first oil pump mounted at the first oil reservoir; and the second oil system further comprises a second oil pump mounted at the second oil reservoir. The first oil system forms a first common oil channel; and the second oil system forms a second common oil channel, the second common oil channel substantially identical to the first common oil channel. Each of the first and second oil systems includes a nut that is centered at a rotor rotation axis, the nut creating an annulus of oil in the first and second common oil channel, respectively. Each of the first and second drive units includes a rotor with an active core, and wherein the nut further includes cross-drilled holes that form a manifold so that oil spins into the active core of the rotor.

### BRIEF DESCRIPTION OF DRAWINGS

FIG. 1 shows an example of a multi-motor electric-vehicle drive unit system.

FIG. 2 shows an example of a drive unit.

FIG. 3 shows another example of a drive unit.

FIG. 4 shows another example view of the drive unit in FIG. 2.

FIG. 5 shows an example cross section of the drive unit in FIG. 3.

FIG. 6 shows an example view of the motor casing of the drive unit in FIG. 2.

FIG. 7 shows an example view of the motor casing of the drive unit in FIG. 3.

FIG. 8 shows an oil inlet in an example cross section of the motor casing of FIG. 6.

FIG. 9 shows an oil inlet in an example cross section of the motor casing of FIG. 7.

FIG. 10 shows another example view of the oil inlet in FIG. 9.

FIG. 11 conceptually shows a common oil channel for either of the drive units in FIGS. 1-2, respectively.

FIG. 12 shows a cover for either of the motor casings of the drive units in FIGS. 2-3, respectively.

FIG. 13 shows an example of structure that can facilitate at least part of the common oil channel in FIG. 11.

FIG. 14 shows another example view of the structure of FIG. 13.

FIG. 15 shows an example cross section of the structure of FIG. 13.

FIG. 16 shows an example of either of the motor casings of the drive units in FIGS. 2-3, respectively, with a rotor and stator.

FIG. 17 shows an example of the motor casing of FIG. 16.

FIG. 18 shows an example of structure that can facilitate at least part of the common oil channel in FIG. 11.

FIG. 19 shows another example view of the structure of FIG. 18.

FIG. 20 shows an example cross section of the structure of FIG. 18.

FIG. 21 shows another example cross section of the nut of FIG. 16.

Like reference symbols in the various drawings indicate like elements.

### DETAILED DESCRIPTION

This document describes examples of systems and techniques for providing drive units for a multi-motor electric-vehicle architecture. A multi-motor architecture can include two or more drive units. A drive unit can include a motor, gearbox, and an inverter, to name just a few examples. Systems and techniques described herein can reduce the complexity of vehicle designs, reduce tooling requirements, and/or reduce production line costs. In some implementations, an electric drive unit can be designed such that is can be installed either in the front motor bay or the rear motor bay of an electric vehicle. For example, the front and rear drive units can share much of the same hardware. This can reduce the complexities when assembling a dual-motor electric vehicle, while allowing the drive units to be adaptable to the possibly different structural surroundings at the various available installation locations. For example, build complexity, bill-of-materials (BOM) complexity, and/or cost can be significantly reduced. In some implementations, both front and rear drive-unit configurations can be built on the same factory production line. In some implementations, a motor casing can be designed to be die cast so that internal passages for oil (or another lubricant and/or coolant) can later be advantageously provided by performing drilling and/or other machining operations.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. A vehicle can be powered exclusively by electricity, or can use one or more other energy source in addition to electricity, to name just a few examples.

Examples herein refer to a drive unit. As used herein, a drive unit includes at least one machine that converts electrical energy into mechanical energy. An inverter can convert direct current into alternating current to power the drive unit. A drive unit can include a rotor and a stator. For example, the drive unit can include a permanent-magnet motor. As another example, the drive unit can include an induction motor. A drive unit includes at least one motor casing. As used herein, when the drive unit includes a rotor and stator, the motor casing substantially contains the rotor and stator. For example, the motor casing can serve as the main housing for the drive unit. In some implementations, the motor casing can have a substantially cylindrical shape. In some implementations, the motor casing can be formed by a casting process. For example, high-pressure die casting (e.g., of aluminum or another material) can be used.

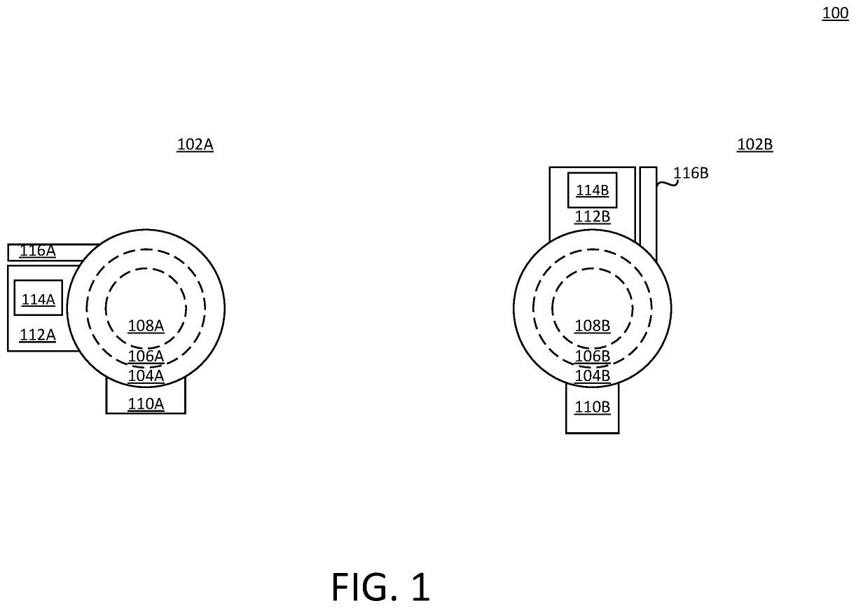

FIG. 1 shows an example of a multi-motor electric-vehicle drive unit system 100. The multi-motor electric-vehicle drive unit system 100 is here schematically shown and can be used with one or more other examples described elsewhere herein. The multi-motor electric-vehicle drive unit system 100 includes drive units 102A-102B. Each of the drive units 102A-102B can be used as a front drive unit and/or as a rear drive unit in an electric vehicle. For example, the drive unit 102A can be used in the rear of the vehicle and the drive unit 102B can be used in the front of the vehicle, or vice versa, to name just a few examples.

The drive unit 102A includes a motor casing 104A and the drive unit 102B includes a motor casing 104B. The motor casing 104B can be identical to the motor casing 104A. In some implementations, the motor casings 104A-104B can be manufactured in a casting process using a common mold cavity. The common mold cavity can be formed by two or more dies. For example, high-pressure die casting of aluminum or another metal can be performed. In some implementations, the motor casings 104A-104B each has a substantially cylindrical shape. The motor casing 104A can include a stator 106A that accommodates a rotor 108A, and the motor casing 104B can include a stator 106B that accommodates a rotor 108B. In some implementations, the rotors 108A-108B can have an active core with a differential. For example, the differential can be a removable differential.

The drive unit 102A can include an oil reservoir 110A, and the drive unit 102B can include an oil reservoir 110B. The oil reservoir 110A is situated at the bottom of the drive unit 102A, and the oil reservoir 110B is situated at the bottom of the drive unit 102B. In some implementations, one of the oil reservoirs 110A-110B can have a different shape than the other. For example, a width of one of the oil reservoirs 110A-110B across one of the stators 106A-106B (e.g., along a horizontal direction in the illustration) can be different. As another example, a depth of one of the oil reservoirs 110A-110B from one of the motor casings (e.g., in a vertical direction in the illustration) can be different. As another example, a length of one of the oil reservoirs 110A-110B along the rotation axis of one of the rotors 108A-108B (e.g., in a direction perpendicular to the plane of the illustration) can be different. The oil reservoirs 110A-110B can alternatively or additionally have one or more other differences.

The drive unit 102A can include an inverter 112A, and the drive unit 102B can include an inverter 112B. The inverters 112A-112B can have an identical mechanical structure as each other. In some implementations, all characteristics of the inverters 112A-112B except one or more aspects of its software (e.g., firmware) can be identical to each other. Such software aspect(s) can relate to the orientation of the drive unit where the inverter 112A or 112B is being used. Any orientation can be used, including, but not limited to, either or both of the shown orientations.

In this illustration, the drive unit 102A is installed so that the inverter 112A has an orientation that is substantially at 9 o'clock with regard to the rest of the drive unit 102A when viewed from the perspective of the current illustration. For example, when the drive unit 102A is installed at the rear of the vehicle, the shown orientation can correspond to the inverter 112A pointing toward the rear end of the vehicle. The inverter 112A can include software 114A that controls the operation of the drive unit 102A. In some implementations, the software 114A can be configured to facilitate operation of the drive unit 102A in a particular orientation (e.g., the orientation that the drive unit 102A has in the illustration). The configuration of the software 114A can relate to one or more reference frames that the drive unit 102A and/or the inverter 112A uses in supplying and/or controlling the electric power that is provided to the drive unit 102A. The software 114A can be configured for such operation before or after the software 114A is installed in the inverter 112A. In some implementations, the software 114A can have multiple modes of operation that support use of the drive unit 102A at two or more orientations (e.g., in both the front and rear positions of the vehicle). After installation, the software 114A can be caused to operate in the operation mode that is applicable based on the orientation of the drive unit 102A. For example, one or more bits of data can be provided to (e.g., flashed to) the inverter 112A from an external computer device to cause the software 114A to operate in the selected mode. Other approaches for configuring the software 114A can be used.

A corresponding description to the above can apply to the inverter 112B in the drive unit 102B. In some implementations, the drive unit 102B is installed so that the inverter 112B has an orientation that is substantially at noon (or midday) with regard to the rest of the drive unit 102B when viewed from the perspective of the current illustration. For example, when the drive unit 102B is installed at the front of the vehicle, the shown orientation can correspond to the inverter 112B pointing upward. The inverter 112B can include software 114B that controls the operation of the drive unit 102B. In some implementations, the software 114B can be configured to facilitate operation of the drive unit 102B in a particular orientation (e.g., the orientation that the drive unit 102B has in the illustration). The configuration of the software 114B can relate to one or more reference frames that the drive unit 102B and/or the inverter 112B uses in supplying and/or controlling the electric power that is provided to the drive unit 102B. The software 114B can be configured for such operation before or after the software 114B is installed in the inverter 112B. In some implementations, the software 114B can have multiple modes of operation that support use of the drive unit 102B at two or more orientations (e.g., in both the front and rear positions of the vehicle). After installation, the software 114B can be caused to operate in the operation mode that is applicable based on the orientation of the drive unit 102B. For example, one or more bits of data can be provided to (e.g., flashed to) the inverter 112B from an external computer device to cause the software 114B to operate in the selected mode. Other approaches for configuring the software 114B can be used.

Either or both of the drive units 102A-102B can include one or more mounts for the respective installation in the vehicle. Here, the drive unit 102A is schematically shown to include a mount 116A, and the drive unit 102B is schematically shown to include a mount 116B. The mounts 116A-116B can be configured for installing the respective drive unit 102A-102B with a corresponding orientation. The mounts 116A-116B can extend from the respective motor casing 104A-104B and can be different from each other. In some implementations, the difference(s) between the mounts 116A-116B are at least in part due to the different installation locations within the vehicle, and the surrounding structure(s) existing at each location. In some implementations, the mount 116A and/or 116B can also or instead connect to the respective inverter 112A and/or 112B. A brace can be used between the mount 116A and/or 116B and the respective inverter 112A and/or 112B, for example as will be described below.

The drive units 102A-102B can be installed in the vehicle so that their orientations relative to each other comprise a rotation about a rotor rotation axis. In some implementations, the orientation of the drive unit 102A as shown can be characterized as the inverter 112A having a particular orientation with regard to the rotation axis of the rotor 108A (e.g., a 9 o'clock position). In some implementations, the orientation of the drive unit 102B as shown can be characterized as the inverter 112B having a particular orientation with regard to the rotation axis of the rotor 108B (e.g., a noon position). The rotation of either of the drive units 102A-102B with regard to the other in the installation can be characterized as corresponding to a particular angle. Any angle can be used. For example, here the drive units 102A-102B are installed with a rotation of about 90 degrees with respect to each other. The oil reservoirs 110A-110B can be mounted at the bottom of the respective motor casing 104A-104B. As such, the positions of the oil reservoirs 110A-110B may be independent of the rotation discussed above.

The following examples summarize some of the aspects mentioned above. The multi-motor electric-vehicle drive unit system 100 can include the drive units 102A-102B. The drive unit 102A can include the motor casing 104A, the oil reservoir 110A, and the inverter 112A. The oil reservoir 110A can be mounted to a bottom of the motor casing 104A. The inverter 112A can be mounted to the motor casing 104A. The drive unit 102A can be installed so that the inverter 112A has a first orientation (e.g., as illustrated). Moreover, the drive unit 102B can include the motor casing 104B, the oil reservoir 110B, and the inverter 112B. The motor casing 104B can be identical to the motor casing 104A. The oil reservoir 110B can be mounted to a bottom of the motor casing 104B. The oil reservoir 110B can have a different shape than the oil reservoir 110A. The inverter 112B can be mounted to the motor casing 104B. The drive unit 102B can be installed so that the inverter 112B has a second orientation (e.g., as illustrated). The second orientation can be different from the first orientation.

The above and/or other approaches described herein can improve the manufacturability and/or combinability of components to be assembled into an electric vehicle. If the motor casings 104A-104B are identical to each other, they can both be manufactured using the same equipment (e.g., a die casting machine), and they can be handled and installed using the same equipment (e.g., one or more robots) as each other. Moreover, the number of different components (e.g., BOM) can be reduced, and sourcing of material and/or components can be made more efficient since the volumes are greater.

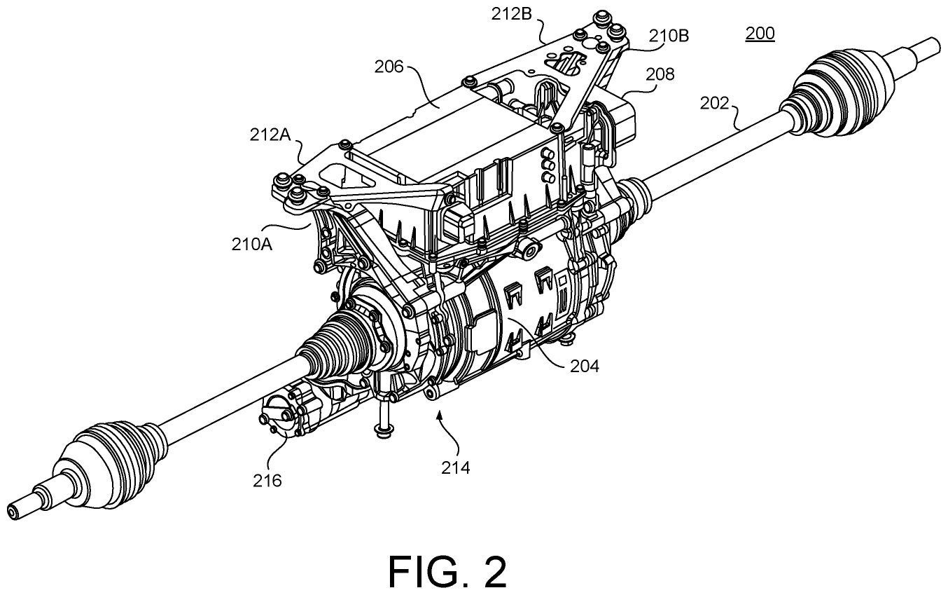

FIG. 2 shows an example of a drive unit 200. The drive unit 200 can be used with one or more other examples described elsewhere herein. In some implementations, the drive unit 200 is an example of the drive unit 102B (FIG. 1). The drive unit 200 can be coupled to at least one axle 202 to provide propulsion to one or more wheels of a vehicle. The drive unit 200 can be installed at any of multiple locations in a vehicle. For example, the drive unit 200 can be installed as a front and/or rear motor.

The drive unit 200 here includes a motor casing 204. In some implementations, the motor casing 204 is die cast from a mold that is used to make multiple motors for the vehicle. For example, high-pressure die casting (e.g., of aluminum) can be used.

The drive unit 200 here includes an inverter 206. The inverter 206 can include circuitry and/or other electrical components to control the supply of electric power to the drive unit 200.

The drive unit 200 here includes a heat exchanger 208. The heat exchanger 208 can be used for transferring heat between two or more heat transfer media. In some implementations, the heat exchanger 208 can transfer heat from a coolant of the inverter 206 into a coolant for the motor casing 204. For example, the inverter 206 can use a water-based coolant and the motor casing 204 can use an oil-based coolant. Other approaches can be used.

The drive unit 200 can include one or more mounts. Here, the drive unit 200 includes mounts 210A-210B at the motor casing 204. The mount 210A and/or 210B can be configured for installing the drive unit 200 so that the inverter 206 has a particular orientation. For example, the mount 210A and/or 210B can facilitate orientation of the inverter 206 to be on top of the motor casing 204 (e.g., upward).

The drive unit 200 can include one or more braces. Here, the drive unit 200 includes braces 212A-212B. The brace 212A and/or 212B can be configured for further supporting the installation of the drive unit 200. A first end of the mount 210A can connect to the motor casing 204, and the brace 212A can connect a second end of the mount 210A, the second end opposite to the first end, to the motor casing 204. Correspondingly, a first end of the mount 210B can connect to the motor casing 204, and the brace 212B can connect a second end of the mount 210B, the second end opposite to the first end, to the motor casing 204. The brace 212A and/or 212B can enclose one or more components of the drive unit 200. For example, the brace 212B and the mount 210B here enclose the heat exchanger 208.

The drive unit 200 can include an oil system. Portions of an oil system are shown here for illustrative purposes. The oil system includes an oil reservoir 214 mounted to a bottom of the motor casing 204. The oil reservoir 214 can serve to collect oil that is draining from the motor casing 204. The oil system can include an oil pump 216 mounted at the oil reservoir 214. In some implementations, the oil pump 216 can cause oil to circulate in the oil system by driving oil through one or more conduits. For example, the oil pump 216 can push oil from the oil reservoir 214 through an oil filter, then through the heat exchanger 208, then through one or more channels (e.g., drillings) in the inverter 206, and thereafter back into the interior of the motor casing 204 in one or more places. The oil channel in which such circulation takes place can be characterized as a common oil channel in that it can be substantially equivalent between two or more installations of drive units, with only minor differences based on orientation.

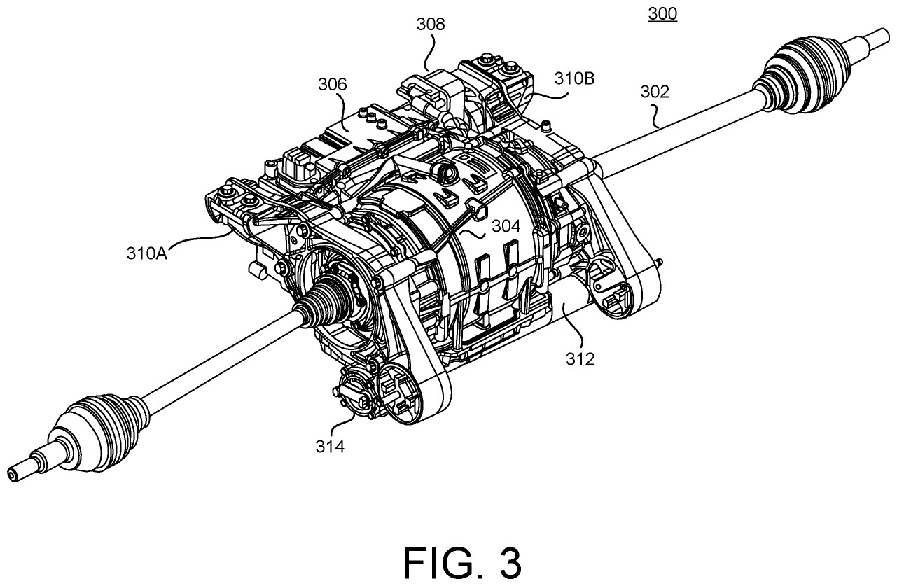

FIG. 3 shows another example of a drive unit 300. The drive unit 300 can be used with one or more other examples described elsewhere herein. Some aspects of the drive unit 300 will be described similarly to the drive unit 200 (FIG. 2). In some implementations, the drive unit 300 is an example of the drive unit 102A (FIG. 1). The drive unit 300 can be coupled to at least one axle 302 to provide propulsion to one or more wheels of a vehicle. The drive unit 300 can be installed at any of multiple locations in a vehicle. For example, the drive unit 300 can be installed as a rear and/or front motor.

The drive unit 300 here includes a motor casing 304. In some implementations, the motor casing 304 is die cast from a mold that is used to make multiple motors for the vehicle. For example, high-pressure die casting (e.g., of aluminum) can be used.

The drive unit 300 here includes an inverter 306. The inverter 306 can include circuitry and/or other electrical components to control the supply of electric power to the drive unit 300.

The drive unit 300 here includes a heat exchanger 308. The heat exchanger 308 can be used for transferring heat between two or more heat transfer media. In some implementations, the heat exchanger 308 can transfer heat from a coolant of the inverter 306 into a coolant for the motor casing 304. For example, the inverter 306 can use a water-based coolant and the motor casing 304 can use an oil-based coolant. Other approaches can be used.

The drive unit 300 can include one or more mounts. Here, the drive unit 300 includes mounts 310A-310B at the motor casing 304. The mount 310A and/or 310B can be configured for installing the drive unit 300 so that the inverter 306 has a particular orientation. For example, the mount 310A and/or 310B can facilitate orientation of the inverter 306 to face rearward in the vehicle.

The drive unit 300 can include an oil system. Portions of an oil system are shown here for illustrative purposes. The oil system includes an oil reservoir 312 mounted to a bottom of the motor casing 304. The oil reservoir 312 can serve to collect oil that is draining from the motor casing 304. The oil system can include an oil pump 314 mounted at the oil reservoir 312. In some implementations, the oil pump 314 can cause oil to circulate in the oil system by driving oil through one or more conduits. For example, the oil pump 314 can push oil from the oil reservoir 312 through an oil filter, then through the heat exchanger 308, then through one or more channels (e.g., drillings) in the inverter 306, and thereafter back into the interior of the motor casing 304 in one or more places. The oil channel in which such circulation takes place can be characterized as a common oil channel in that it can be substantially equivalent between two or more installations of drive units, with only minor differences based on orientation.

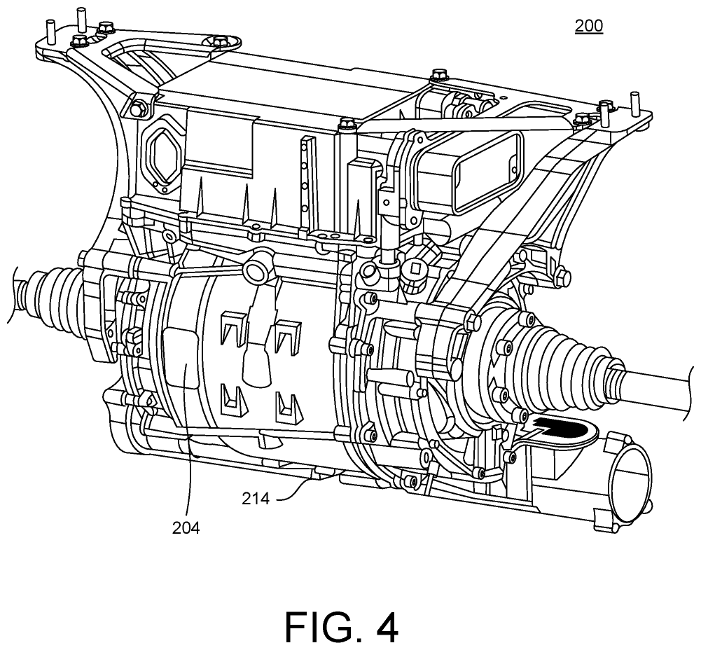

FIG. 4 shows another example view of the drive unit 200 in FIG. 2. The oil reservoir 214 of the oil system extends along a bottom of the motor casing 204 in the direction of the rotor rotation axis.

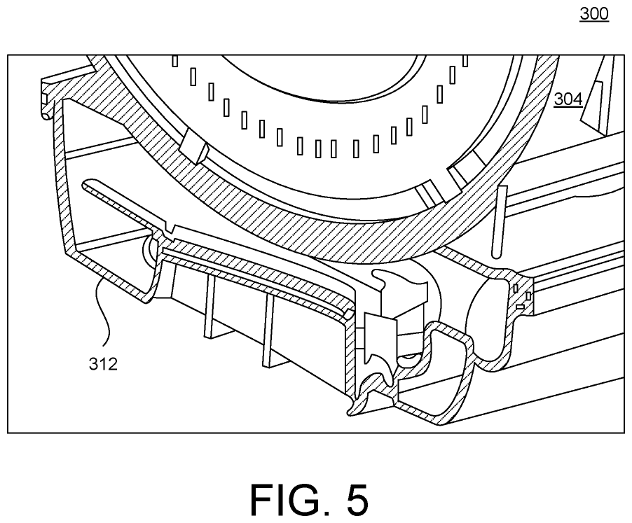

FIG. 5 shows an example cross section of the drive unit 300 in FIG. 3. The oil reservoir 312 can be shaped to facilitate installation of the drive unit 300 in a relatively confined space. One or more dimensions of the oil reservoir 312 can be chosen accordingly. For example, the oil reservoir 312 can have a relatively small depth in the radial direction from the motor casing 304 (e.g., a z-direction).

It has been mentioned that one or more components described herein can be used in different installations (e.g., as either front and rear versions) of drive units. Such component(s) can be manufactured so as to initially be adaptable to each of the different installations. Once the installation for a particular component has been designated, that component can be adapted in one or more ways to tailor it to the specific type of installation. For example, such adaptation can include performing machining of one or more of the initially present structures into a functional structure, while not machining one or more similar initially present other structures, thereby leaving the other structures to remain not functional. Examples described below illustrate this.

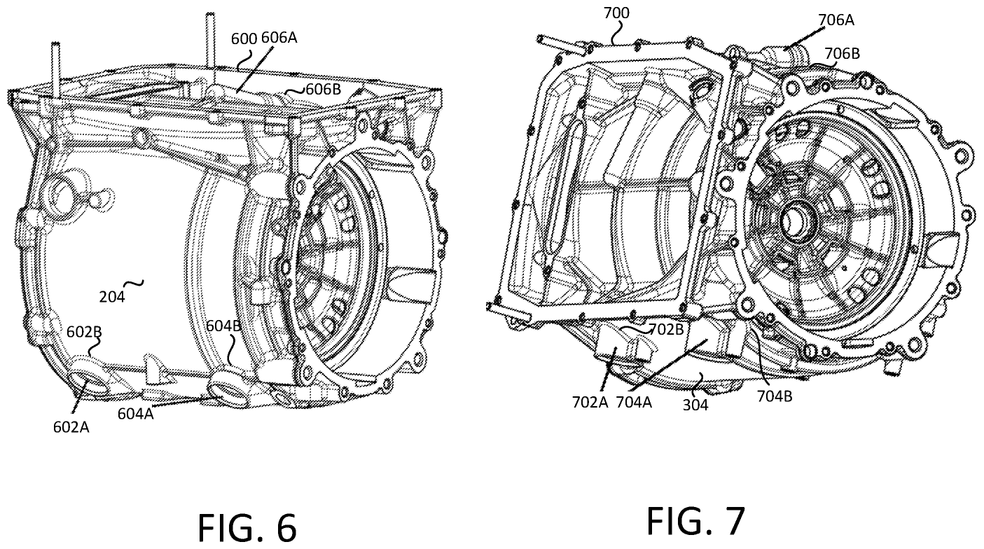

FIG. 6 shows an example view of the motor casing 204 of the drive unit 200 in FIG. 2. The motor casing 204 can be configured for use in any of multiple different orientations. In some implementations, the motor casing 204 can be used such that an inverter mount 600 is oriented upward relative to the rest of the drive unit. For example, this orientation can be associated with installation at a particular location in the vehicle (e.g., at the front).

Here, the motor casing 204 has been provided with drain ports 602A and 604A. The drain ports 602A and 604A can be positioned at or toward what will be a bottom of the motor casing 204 when installed. The drain ports 602A and 604A can be machined at drain port structures 602B and 604B, respectively. That is, the motor casing 204 can be manufactured (e.g., die cast) to include the drain port structures 602B and 604B. To facilitate operation in the shown orientation, the drain ports 602A and 604A can be machined (e.g., drilled and/or otherwise installed) at the drain port structures 602B and 604B, respectively. This can provide useful flexibility in the manufacturing of the motor casing 204. For example, the motor casing 204 as manufactured (e.g., cast) can initially include both the drain port structures 602B and 604B and also one or more other drain port structures associated with operating in a different orientation. In the motor casing 204, those other drain port structures are not machined and remain not functional.

Here, the motor casing 204 has been provided with an oil inlet 606A. The oil inlet 606A can be positioned to introduce oil at or toward what will be a top of the motor casing 204 when installed. The oil inlet 606A can be machined at oil inlet structure 606B. That is, the motor casing 204 can be manufactured (e.g., die cast) to include the oil inlet structure 606B. To facilitate operation in the shown orientation, the oil inlet 606A can be machined (e.g., drilled and/or otherwise installed) at the oil inlet structure 606B. This can provide useful flexibility in the manufacturing of the motor casing 204. For example, the motor casing 204 as manufactured (e.g., cast) can include both the oil inlet structure 606B and also one or more other oil inlet structures associated with operating in a different orientation. In the motor casing 204, that other oil inlet structure is not machined and remains not functional.

FIG. 7 shows an example view of the motor casing 304 of the drive unit 300 in FIG. 3. Some aspects of the motor casing 304 will be described similarly to the motor casing 204 (FIG. 6). The motor casing 304 can be configured for use in any of multiple different orientations. In some implementations, the motor casing 304 can be used such that an inverter mount 700 is oriented sideways relative to the rest of the drive unit. For example, this orientation can be associated with installation at a particular location in the vehicle (e.g., at the rear).

Here, the motor casing 304 has been provided with drain ports 702A and 704A. The drain ports 702A and 704A can be positioned at or toward what will be a bottom of the motor casing 304 when installed. The drain ports 702A and 704A can be machined at drain port structures 702B and 704B, respectively. That is, the motor casing 304 can be manufactured (e.g., die cast) to include the drain port structures 702B and 704B. To facilitate operation in the shown orientation, the drain ports 702A and 704A can be machined (e.g., drilled and/or otherwise installed) at the drain port structures 702B and 704B, respectively. This can provide useful flexibility in the manufacturing of the motor casing 304. For example, the motor casing 304 as manufactured (e.g., cast) can initially include both the drain port structures 702B and 704B and also one or more other drain port structures associated with operating in a different orientation. In the motor casing 304, those other drain port structures are not machined and remain not functional.

Here, the motor casing 304 has been provided with an oil inlet 706A. The oil inlet 706A can be positioned to introduce oil at or toward what will be a top of the motor casing 304 when installed. The oil inlet 706A can be machined at oil inlet structure 706B. That is, the motor casing 304 can be manufactured (e.g., die cast) to include the oil inlet structure 706B. To facilitate operation in the shown orientation, the oil inlet 706A can be machined (e.g., drilled and/or otherwise installed) at the oil inlet structure 706B. This can provide useful flexibility in the manufacturing of the motor casing 304. For example, the motor casing 304 as manufactured (e.g., cast) can include both the oil inlet structure 706B and also one or more other oil inlet structures associated with operating in a different orientation. In the motor casing 304, that other oil inlet structure is not machined and remains not functional.

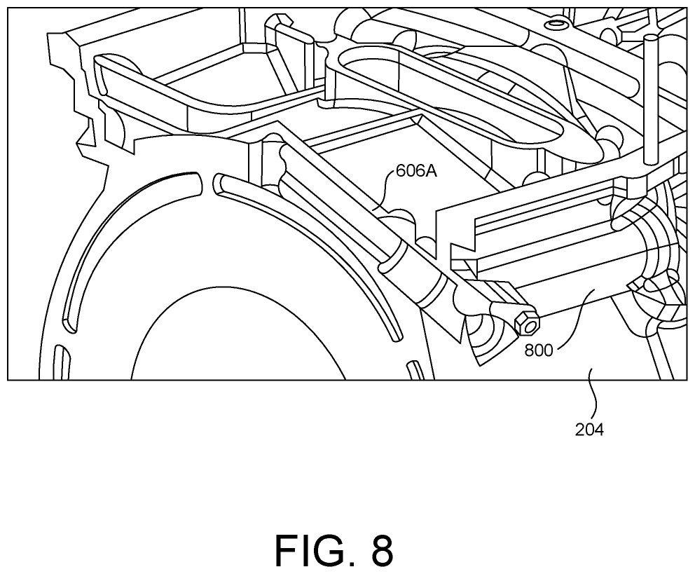

FIG. 8 shows the oil inlet 606A in an example cross section of the motor casing 204 of FIG. 6. That is, the oil inlet 606A has here been machined (from the oil inlet structure 606B, see FIG. 6), whereas the oil inlet structure 706B has not been machined (that is, unlike in FIG. 7) and here remains not functional. Other approaches can be used. The oil inlet 606A can be in fluid communication with a common oil inlet 800 that extends axially along the rotor rotation axis of the motor casing 204. That is, the common oil inlet 800 can be part of the motor casing 204 as manufactured (e.g., when cast) and can be used either with the oil inlet 606A or with another oil inlet (e.g., the oil inlet 706A in FIG. 7).

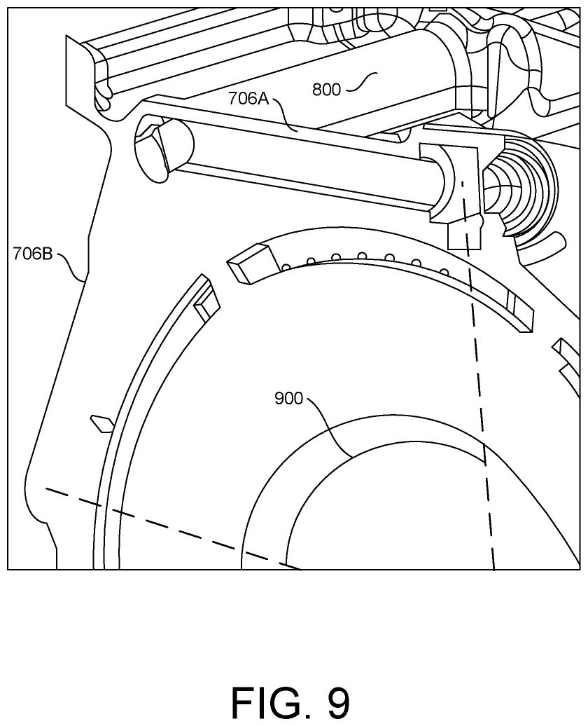

FIG. 9 shows the oil inlet 706A in an example cross section of the motor casing 304 of FIG. 7. That is, the oil inlet 706A has here been machined (from the oil inlet structure 706B, see FIG. 7), whereas the oil inlet structure 606B has not been machined (that is, unlike in FIG. 6) and here remains not functional. Other approaches can be used. The oil inlet 706A can be in fluid communication with the common oil inlet 800. That is, the common oil inlet 800 can be part of the motor casing 304 as manufactured (e.g., when cast) and can be used either with the oil inlet 706A or with another oil inlet (e.g., the oil inlet 606A in FIG. 6). The oil inlet structures 706A and 706B can extend circumferentially in opposite directions from the common oil inlet 800 about the rotor rotation axis, for example as shown. In some implementations, the oil inlet structures 706A and 706B extend circumferentially over an angle 900 as schematically shown indicated between respective radiuses of the motor casing 304. The angle 900 can have any value. For example, the angle 900 can be about 45 degrees.

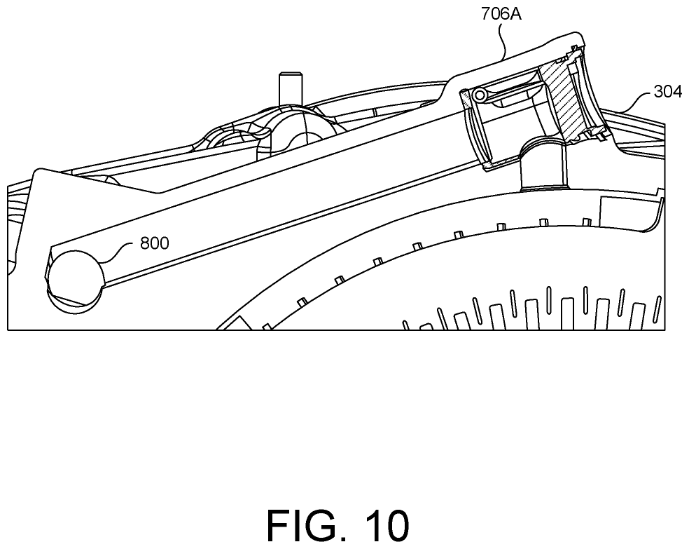

FIG. 10 shows another example view of the oil inlet 706A in FIG. 9. This example shows that the oil inlet 706A is configured to introduce oil from the common oil inlet 800 into an opening that is essentially at the top of the motor casing 304.

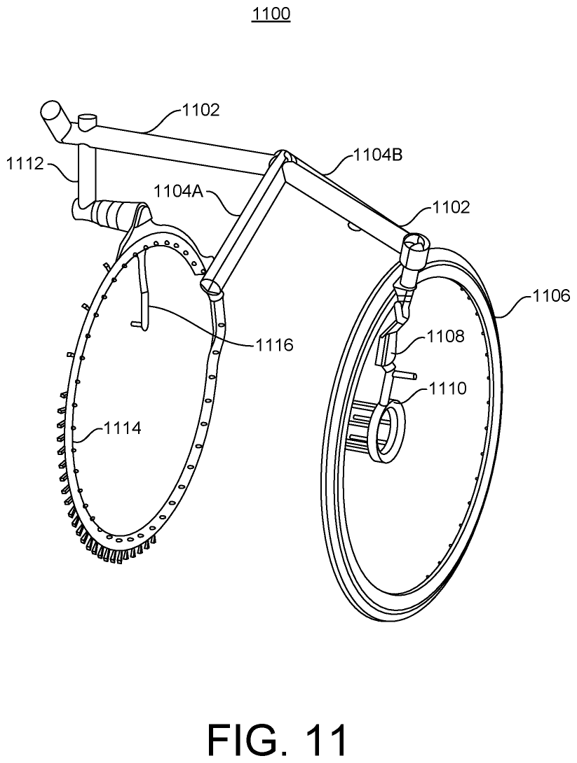

FIG. 11 conceptually shows a common oil channel 1100 for either of the drive units 200 or 300 in FIGS. 2-3, respectively. The common oil channel 1100 can be used with one or more other examples described elsewhere herein. The common oil channel 1100 illustrates the cavities, passages, or other openings through which oil can be circulated in a drive unit. For clarity, the surrounding structures that define such cavities, passages, or other openings are not shown in the illustration, but rather only the shape of the body of (circulating) oil is depicted.

Beginning toward the left side of the illustration, the common oil channel 1100 can include a common oil inlet 1102. For example, the common oil inlet 1102 can correspond to the common oil inlet 800 (FIGS. 8-9). In the drive unit 200 (FIG. 2), the common oil channel 1100 can be substantially identical to the common oil channel 1100 in the drive unit 300 (FIG. 3), except for minor differences due to orientation. For example, the common oil channel 1100 can include an oil inlet 1104A or an oil inlet 1104B (partially obscured, and similar in shape to the oil inlet 1104A). The oil inlet 1104A can correspond to the oil inlet 606A (FIG. 8), and the oil inlet 1104B can correspond to the oil inlet 706A (FIG. 9). As such, the common oil channel 1100 can have only one, and not the other, of the oil inlets 1104A-1104B.

The common oil inlet 1102 continues to extend past the oil inlet 1104A or 1104B and forms a ring 1106. In some implementations, the ring 1106 can provide oil to or near an end cover of a motor casing. For example, this can facilitate cooling at end turns of stator windings. The common oil channel 1100 can include a feed 1108. In some implementations, the feed 1108 can be substantially radial with regard to the ring 1106. For example, the feed 1108 can facilitate that oil is provided to or near the rotational center of the drive unit. The common oil channel 1100 can provide a manifold 1110 for oil flow at the end of the rotor. In some implementations, this can furnish oil onto and/or inside a rotor axle. For example, this can provide cooling for a differential and/or active core.

The common oil channel 1100 includes a feed 1112. In some implementations, the feed 1112 can facilitate oil flow toward another end of the motor casing. For example, the feed 1112 can provide oil flow to a ring 1114. The ring 1114 can provide cooling of other end turns of the stator of the drive unit. For example, the ring 1114 can supply oil at or near stator terminals. As another example, the feed 1112 can provide oil flow to a branch 1116. The branch 1116 can provide oil at or near a rotational center of the drive unit. Oil that is distributed by any of the above-described aspects of the common oil channel 1100 can eventually collect at or near a bottom of the motor casing by way of gravity. For example, one or more drain holes (e.g., as described elsewhere herein) can facilitate egress of the accumulated oil into an oil reservoir and/or an oil pump (e.g., as described elsewhere herein).

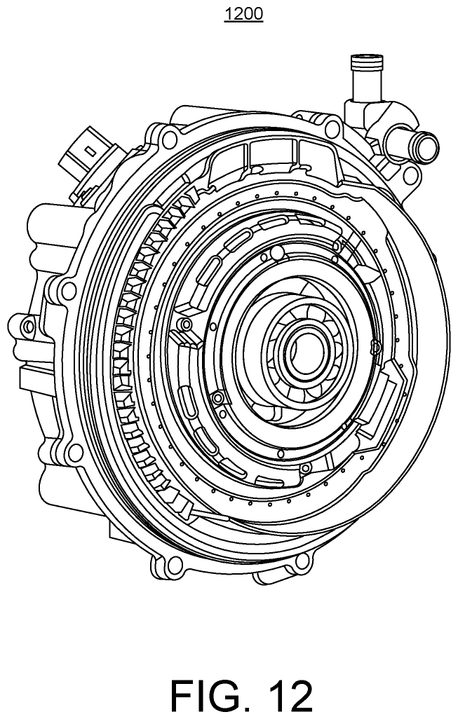

FIG. 12 shows a cover 1200 for either of the motor casings 204 or 304 of the drive units 200 and 300 in FIGS. 2-3, respectively. The cover 1200 can be used with one or more other examples described elsewhere herein. The cover 1200 can hold one end of a rotor axle and can facilitate distribution of oil to one or more locations inside the motor casing. As such, the cover 1200 can include one or more passages, shapes, and/or other structures that help guide the flow of oil, for example as described below.

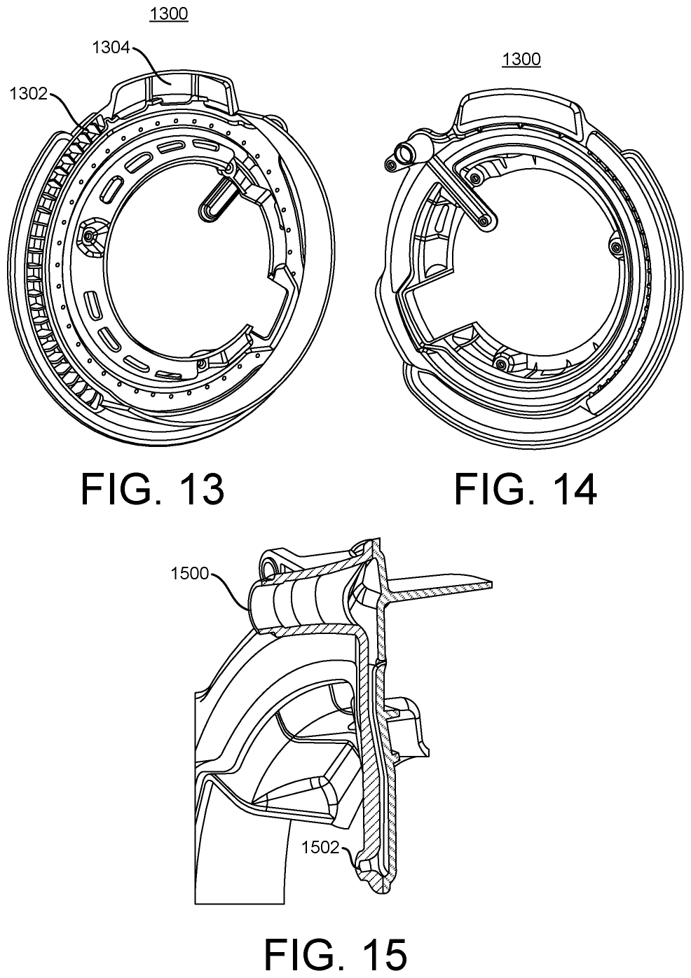

FIG. 13 shows an example of structure 1300 that can facilitate at least part of the common oil channel 1100 in FIG. 11. FIG. 14 shows another example view of the structure 1300 of FIG. 13. The structure 1300 can be used with one or more other examples described elsewhere herein. For example, the structure 1300 can be included in the cover 1200 (FIG. 12). The structure 1300 can include one or more passages, shapes, and/or other structures to guide the flow of oil. For example, the structure 1300 includes openings 1302 corresponding to the respective positions of stator terminals (e.g., of the stator 106A and/or 106B in FIG. 1). As another example, the structure 1300 includes openings 1304 corresponding to the respective positions of stator lugs (e.g., of the stator 106A and/or 106B in FIG. 1). In some implementations, the structure 1300 can provide at least part of the common oil channel 1100 (FIG. 11). For example, the structure 1300 can provide at least the ring 1114 (FIG. 11). As another example, the structure 1300 can provide at least part of the branch 1116 (FIG. 11). FIG. 15 shows an example cross section of the structure 1300 of FIG. 13. An opening 1500 can facilitate oil flow through the branch 1116 (FIG. 11) to an outlet 1502.

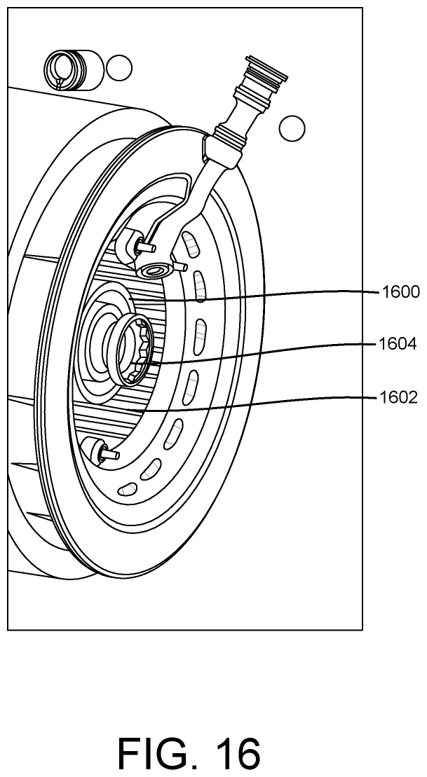

FIG. 16 shows an example of either of the motor casings 204 or 304 of the drive units 200 and 300 in FIGS. 2-3, respectively, with a rotor 1600 and stator 1602. The rotor 1600 here includes an active core. For example, the rotor 1600 can include a differential located inside a hollow rotor axis. The drive unit includes a nut 1604 that is centered with regard to the rotor rotation axis. The nut can create an annulus of oil that cools at least the rotor 1600. Such annulus of oil can be formed as part of circulating oil in a common oil channel (e.g., FIG. 11).

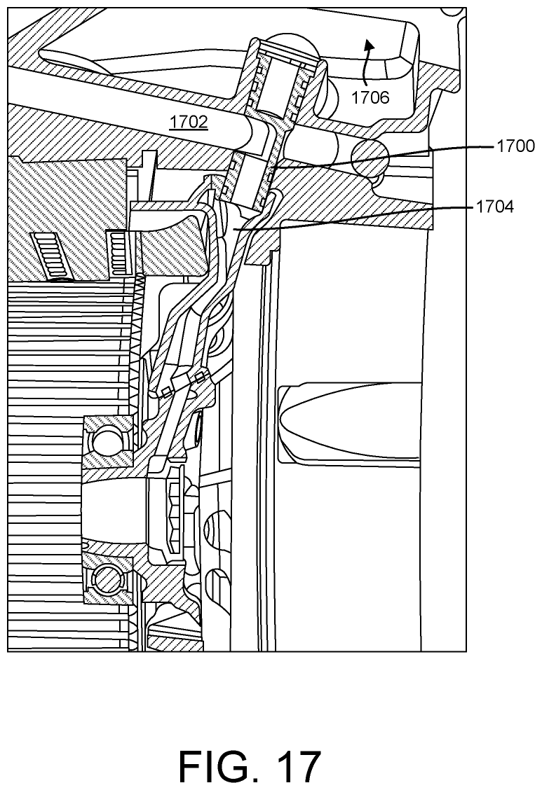

FIG. 17 shows an example of the motor casing of FIG. 16. A plug 1700 can serve at least a dual role in the drive unit. First, the plug 1700 can guide oil of a common oil channel 1702 (compare with the common oil channel 1100 in FIG. 11) into a channel 1704 that is also part of the common oil channel 1702. Second, the plug 1700 can prevent oil from leaking into an inverter 1706 through an end of the channel 1704.

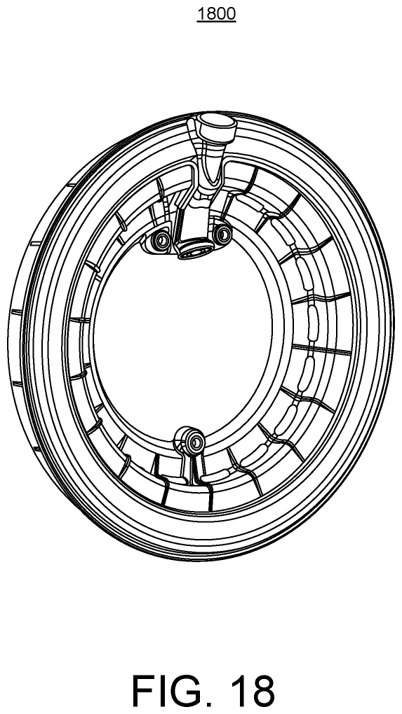

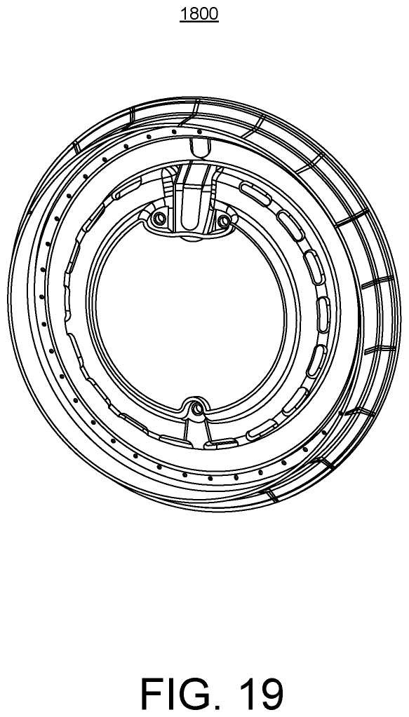

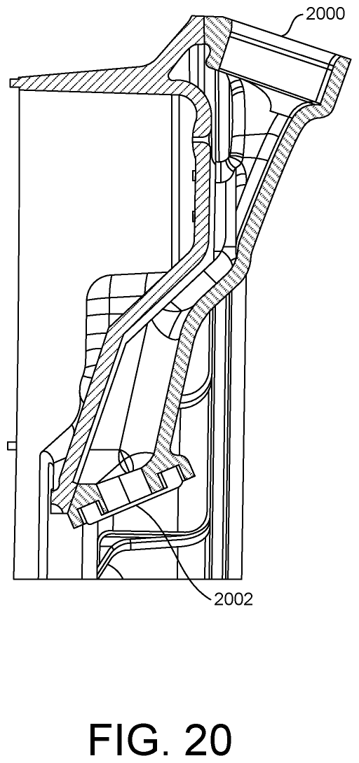

FIG. 18 shows an example of structure 1800 that can facilitate at least part of the common oil channel 1100 in FIG. 11. FIG. 19 shows another example view of the structure 1800 of FIG. 18. The structure 1800 can be used with one or more other examples described elsewhere herein. For example, the structure 1800 can be included in the cover 1200 (FIG. 12). The structure 1800 can include one or more passages, shapes, and/or other structures to guide the flow of oil. In some implementations, the structure 1800 can provide at least the feed 1108 (FIG. 11). FIG. 20 shows an example cross section of the structure 1800 of FIG. 18. An opening 2000 can facilitate oil flow through the feed 1108 (FIG. 11) to an outlet 2002.

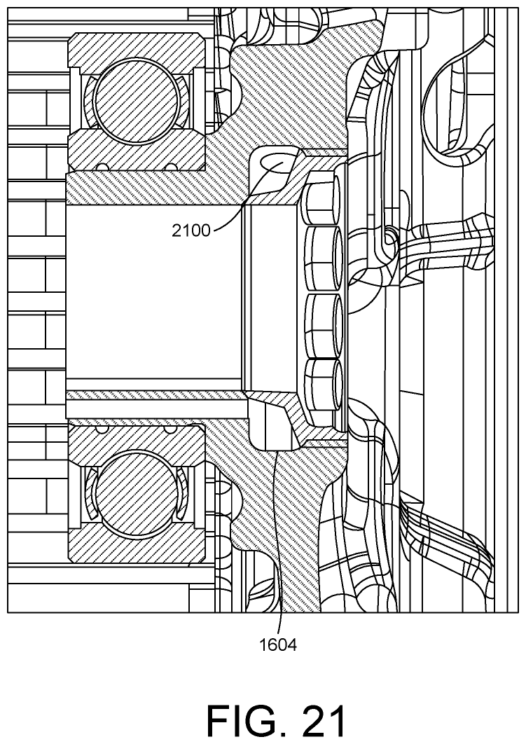

FIG. 21 shows another example cross section of the nut 1604 of FIG. 16. The nut 1604 can be used with one or more other examples described elsewhere herein. The nut 1604 further includes at least one cross-drilled hole 2100 that forms a manifold so that oil spins into the active core of the rotor. In some implementations, this can provide the manifold 1110 (FIG. 11). For example, the cross-drilled hole 2100 can serve to convey oil from the channel 1704 (FIG. 17) toward the active core of a hollow rotor axis.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A multi-motor electric-vehicle drive unit system comprising:
a first drive unit comprising:
a first motor casing;
a first oil reservoir mounted to a bottom of the first motor casing; and
a first inverter mounted to the first motor casing, wherein the first drive unit is installed so that the first inverter has a first orientation; and
a second drive unit comprising:
a second motor casing, wherein the second motor casing is identical to the first motor casing;
a second oil reservoir mounted to a bottom of the second motor casing, wherein the second oil reservoir has a different shape than the first oil reservoir; and
a second inverter mounted to the second motor casing, wherein the second drive unit is installed so that the second inverter has a second orientation, the second orientation different from the first orientation.

2. The multi-motor electric-vehicle drive unit system of claim 1, wherein each of the first and second motor casings has a cylindrical shape.

3. The multi-motor electric-vehicle drive unit system of claim 1, wherein the second motor casing is identical to the first motor casing due to the first and second motor casings being die cast.

4. The multi-motor electric-vehicle drive unit system of claim 1, wherein the first inverter has an identical mechanical structure to the second inverter.

5. The multi-motor electric-vehicle drive unit system of claim 4, further comprising:
first software in the first inverter, the first software configured for controlling operation of the first drive unit with the first inverter in the first orientation; and
second software in the second inverter, the second software different from the first software, the second software configured for controlling operation of the second drive unit with the second inverter in the second orientation.

6. The multi-motor electric-vehicle drive unit system of claim 1, wherein:
the first drive unit further comprises a first mount at the first motor casing, the first mount configured for installing the first drive unit so that the first inverter has the first orientation; and
the second drive unit further comprises a second mount at the second motor casing, the second mount different from the first mount, the second mount configured for installing the second drive unit so that the second inverter has the second orientation.

7. The multi-motor electric-vehicle drive unit system of claim 6, wherein the first drive unit further comprises a brace, wherein a first end of the first mount connects to the first motor casing, and wherein the brace connects a second end of the brace to the first motor casing, the second end being opposite to the first end.

8. The multi-motor electric-vehicle drive unit system of claim 7, wherein the brace and the first mount enclose a heat exchanger for the first drive unit.

9. The multi-motor electric-vehicle drive unit system of claim 1, wherein each of the first and second motor casings initially includes a first drain port structure and a second drain port structure, wherein the first drain port structure of the first motor casing is machined into a first drain port and wherein the second drain port structure of the first motor casing is not functional, and wherein the first drain port structure of the second motor casing is not functional and wherein the second drain port structure of the second motor casing is machined into a second drain port.

10. The multi-motor electric-vehicle drive unit system of claim 1, wherein each of the first and second motor casings initially includes a first oil inlet structure and a second oil inlet structure, wherein the first oil inlet structure of the first motor casing is machined into a first oil inlet and wherein the second oil inlet structure of the first motor casing is not functional, and wherein the first oil inlet structure of the second motor casing is not functional and wherein the second oil inlet structure of the second motor casing is machined into a second oil inlet.

11. The multi-motor electric-vehicle drive unit system of claim 10, wherein each of the first and second motor casings further includes a common oil inlet channel extending axially, and wherein the first and second oil inlet structures extend circumferentially in opposite directions from the common oil inlet channel.

12. The multi-motor electric-vehicle drive unit system of claim 11, wherein each of the first and second oil inlet structures extends circumferentially about 45 degrees about a rotor rotation axis from the common oil inlet channel.

13. The multi-motor electric-vehicle drive unit system of claim 1, wherein the first and second drive units are installed so that the first and second orientations comprise a rotation of the second drive unit, relative to the first drive unit, about a rotor rotation axis.

14. The multi-motor electric-vehicle drive unit system of claim 13, wherein the rotation is about 90 degrees.

15. The multi-motor electric-vehicle drive unit system of claim 1, wherein:
the first motor casing includes a first inverter mount, wherein the first inverter is mounted to the first motor casing using the first inverter mount; and
the second motor casing includes a second inverter mount, the second inverter mount identical to the first inverter mount, wherein the second inverter is mounted to the second motor casing using the second inverter mount.

16. The multi-motor electric-vehicle drive unit system of claim 1, wherein:
the first drive unit further comprises a first oil system that includes the first oil reservoir; and
the second drive unit further comprises a second oil system that includes the second oil reservoir.

17. The multi-motor electric-vehicle drive unit system of claim 16, wherein:
the first oil system further comprises a first oil pump mounted at the first oil reservoir; and
the second oil system further comprises a second oil pump mounted at the second oil reservoir.

18. The multi-motor electric-vehicle drive unit system of claim 16, wherein:
the first oil system forms a first common oil channel; and
the second oil system forms a second common oil channel, the second common oil channel substantially identical to the first common oil channel.

19. The multi-motor electric-vehicle drive unit system of claim 18, wherein each of the first and second oil systems includes a nut that is centered at a rotor rotation axis, the nut creating an annulus of oil in the first and second common oil channel, respectively.

20. The multi-motor electric-vehicle drive unit system of claim 19, wherein each of the first and second drive units includes a rotor with an active core, and wherein the nut further includes cross-drilled holes that form a manifold so that oil spins into the active core of the rotor.
